(19) United States
(12) Patent Application Publication
(10) Pub. No.: US 2004/0010691 A1
(43) Pub. Date: Jan. 15, 2004

(54) Method for authenticating digital content in frames having a minimum of one bit per frame reserved for such use

(76) Inventor: Terence J. Nelson, New Providence, NJ (US)

Correspondence Address: HARNESS, DICKEY & PIERCE, P.L.C., P.O. BOX 828, BLOOMFIELD HILLS, MI, 48303, US

(21) Appl. No.: 10/195,574

(22) Filed: Jul. 15, 2002

(51) Int. Cl. H04L 9/00

(52) U.S. Cl. 713/176

(57) ABSTRACT

A method and/or system for defining the proprietary status of a digital work disposed in a digital medium. The content frames of the work each have at least one proprietary status frame bit along with the content bits. The method first derives a hash value from the content bits of a selected plurality of the content frames, appends a digital proprietary identifier to the hash value, encrypts the concatenated identifier and hash value to derive a digital certificate, and modifies the proprietary status frame bits to collectively contain the digital certificate. The method is applicable to works purchased from a store and also to works acquired over the Internet.

### FIELD OF THE INVENTION

This invention relates to computer medium authentication methods and systems and to methods for identifying possible theft of intellectual property in a work.

### BACKGROUND OF THE INVENTION

Over 50% of US homes now have personal computers (PCs), and writable compact disk (CD) technology for PCs is already also quite affordable. Writable digital video disk (DVD) systems for PCs are also available and should be readily affordable in the broad consumer market in the near future. Along with the high prevalence of CD players, portable CD players, DVD players, and portable DVD players, these capabilities in PCs create a dilemma for content providers. In this regard, disc-level copy-protection technologies are essentially nonexistent for audio CDs in the general consumer market, and disc-level copy-protection technologies are easily broken in the case of video DVDs marketed to the broad consumer market. Confounding a solution to this situation is the ability to produce a disc writer that does not block copying; even if an agreement can be reached or if the legal process establishes regulations respective to security protocols in this concern, there will be a strong motivation on the part of parties who do not subscribe to such an agreement or to such regulations to produce such writers when writable discs become affordable from which (legally or illegally) copied content can be played.

An alternative approach to copyright protection makes use of un-forgeable digital certificates that identify the licensee and can be used to prove that the content is authentic. Each user receives a somewhat different copy, and this method is accordingly not economically feasible for distribution of content on stamped discs. Such an approach is feasible, however, for content distribution over networks or on writable discs.

Un-forgeable certificates are, in one embodiment, made in a three-step process. First, the content is hashed to a fixed number of bits (hashing is the general changing of a set of data into a fixed-length form according to a method defined for the situation where the change is executed). Secure hash functions have been devised, such as MD5, which are difficult to invert. Accordingly, the content is presumed to be authentic if the hash value (also known as a digital fingerprint) matches it and is itself authentic. In the second step, the secure hash value is combined with the digital ID of the licensee. For example, MD5 produces 128-bit hash values. An ID of 112 bytes would bring the total length of the certificate up to 128 bytes=1024 bits, which is conveniently a power of 2. The third step uses a public-key encryption algorithm such as RSA. RSA encryption using 1024-bit blocks (with a modulus that is slightly longer and equal to the product of two large prime numbers) is currently considered sufficiently secure for most considerations. The point of public-key encryption is that anyone can decode an encrypted message using the public key, but a private key is required to encrypt a message. Since it is not feasible to compute the private key from the information made public by the content provider, an encrypted certificate that contains secure hash values that match the content must be authentic.

Ideally, un-forgeable digital certificates are written in fields in the headers of frames into which digital content is typically divided and thereby propagate to copies. However, as pointed out by James M. Barton in U.S. Pat. No. 6,115,818, “The size and format of these fields does not usually provide sufficient space, security, or reliability to allow the transmission of sensitive data, such as authentication information.” For example, MP3 has only one bit per frame, the “private” bit, which can be used without fear of tripping existing decoders (see Scott Hacker's book MP3: The Definitive Guide, O'Reilly, Sebastopol, Calif. 2000.) In the case of DVD Video, a 6-byte field called CPR_MAI (Copyright Management Information) is available; however, such an approach is still marginal for a secure hash value and is deficient respective to providing added information identifying the licensee. It is also to be noted that some of the bits in CPR_MAI are already used by DVD-Video.

Faced with this paucity of available security bits, various methods have been proposed to embed metadata in the content itself (e.g., Barton as earlier referenced). While such attempts change the content in ways that achieve some degree of security, they nevertheless also destroy authenticity in the content. Furthermore, data formats such as MP3 and DVD-Video already use perceptual encoding to reduce the number of content bits as much as possible consistent with the intended fidelity of playback.

What is needed is an approach to digital medium authentication which authenticates ownership, preserves the content of the authenticated digital work, and is compatible with current approaches in providing content to the existing base of playing machines. The present invention provides a solution to this set of needs.

### SUMMARY OF THE INVENTION

The invention provides a method for defining the proprietary status of a digital work disposed in a digital medium, where the work has a set of content frames with each content frame having a set of content bits and at least one proprietary status frame bit. The method uses the following steps:

defining a plurality of the content frames from the set of content frames;

deriving a hash value from the content bits in the plurality of content frames;

appending a digital proprietary identifier to the hash value to define a concatenated data object;

encrypting the concatenated data object to derive a digital certificate having a number of bits equivalent to the number of proprietary status frame bits in the plurality of content frames; and

modifying the proprietary status frame bits in the plurality of content frames to collectively contain the digital certificate.

The invention is also for systems which implement the above process and for enhancements to the above process which are specific to particular users of the process.

The invention is further appreciated from a consideration of the Figures and the Detailed Description Of The Preferred Embodiments.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 presents an overview of components in a standard computer system capable of implementing authentication as described herein and also of playing a digital work.

FIG. 2 presents key steps in defining the proprietary status of a digital work disposed in a digital medium.

FIG. 3 presents detail in the interrelationship of key data elements used in the steps of FIG. 2.

### DETAILED DESCRIPTION OF THE PREFERRED EMBODIMENTS

The following description of the preferred embodiment(s) is merely exemplary in nature and is in no way intended to limit the invention, its application, or uses.

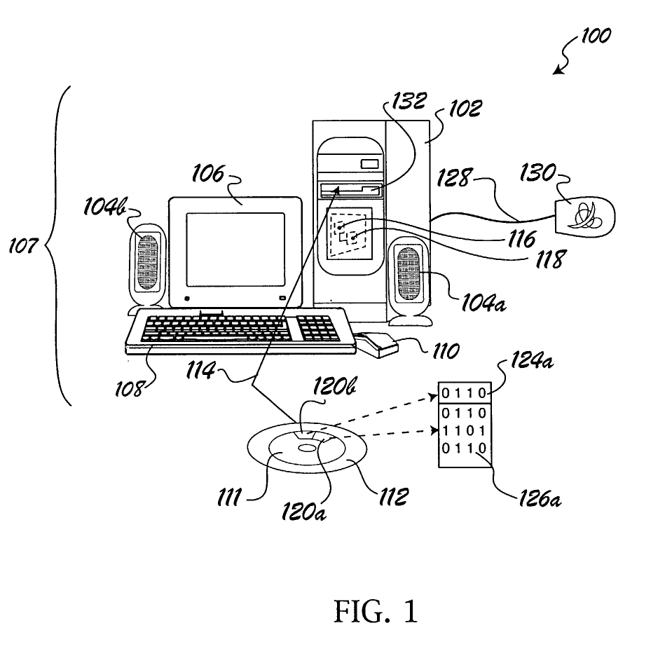

FIG. 1 shows Computer System 100 having Computer 102 in interconnection with Monitor 106 for visual output and with Speakers 104a, 104b for audio output. Control inputs from human users to Computer 102 are enabled from Keyboard 108 and from Mouse 110. Data sources for Computer 102 are provided as Internet 130 which interfaces with Computer 102 via Network Cable 128 and from Digital Medium 112 as either a CD ROM (read-only compact disk), CD-RW (read-write compact disk), or DVD (digital video disk). As is widely appreciated, Digital Media 112 provides a source, in different specific embodiments, for games, music, movies, photographs, application programs, electronic books, artwork images, and the like. Computer 102 has Central Processing Unit 116 for processing Executable Logic 118. Executable Logic 118 is usually disposed is the form of coded instructions in either read-only memory electronic circuitry (ROM) or in random access memory electronic circuitry (RAM) as a series of TRUE and/or FALSE Boolean bits. Collectively, these bits represent, at any given moment of real-time, a portion of a work being enjoyed by the human user and/or a program which Computer 102 executes to perform a useful task. Such a digital work is provided to Computer 102 in one instance as Digital Work 111 as disposed on Digital Medium 112 when Digital Medium 112 is inserted via Vector 114 into Disk Drive 132 in Computer 102. Digital Work 111 is provided as a series of content frames; FIG. 1 shows Content Frame 120a and also Content Frame 120b as an exemplary subset of the set of content frames providing Digital Work 111 in Digital Medium 112. Content Frames 120a, 120b are each defined by two separate sets of frame data with Content Bits 126a and Proprietary Status Frame Bit(s) 124a being shown in FIG. 1 respective to Content Frame 120a. In another instance, Digital Work 111 is provided as a series of content frames provided as a serial data transmission from Internet 130. Such a serial transmission also is also provided in a set of serially-received Content Frames 120a, 120b. In other embodiments, Digital Medium 112 is alternatively provided as a tape, a wireless signal, a bubble memory, or the like.

While Computer 102 in interconnection with Monitor 106, Speakers 104a, 104b, Keyboard 108, and Mouse 110 provides an embodiment of Digital Playing Apparatus 107 for performing an enjoyable or useful work, other customized embodiments of Digital Playing Apparatus 107 are well-known as CD players, DVD players, home theater systems, tape players, and the like.

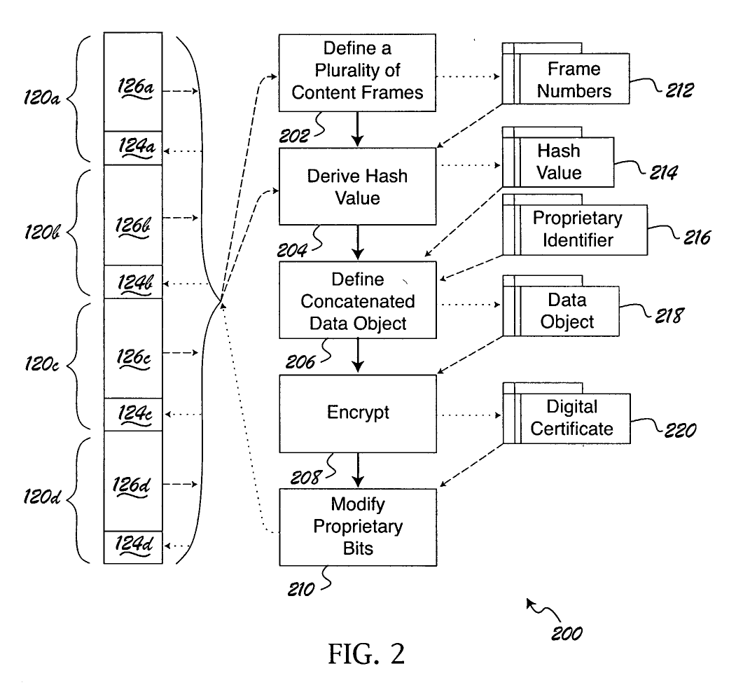

Turning now to FIG. 2, key steps in defining the proprietary status of a digital work disposed in a digital medium are shown. FIG. 2 shows Stepwise Authentication Process 200 in which an initial set of exemplary Content Frames 120a, 120b, 120c, 120d are modified to a new set of Content Frames 120a, 120b, 120c, 120d containing Digital Certificate 220. Stepwise Authentication Process 200 is, therefore, a program deployed in Executable Logic 118 which Computer 102 executes to achieve the authentication of the work disposed in Content Bits 126a, 126b, 126c, and 126d. As should be appreciated, most works extend for a substantial number of additional frames.

In Step 202, Content Frames 120a-120d are defined as a plurality of content frames from the set of content frames which constitute Digital Work 111. The frame numbers (addresses) are stored in Frame Number Cache 212 for reference in determining Hash Value 214 and also for eventual reference in writing Digital Certificate 220 into Proprietary Bits 124a-124d. In Step 204, a hash value is derived from the content bits in Content Frames 120a-120d and is stored in Hash Value 214. In Step 206, Digital Proprietary Identifier 216 is appended to Hash Value 214 to define concatenated Data Object 218. In Step 208, Data Object 218 is encrypted to derive Digital Certificate 220 having a number of bits equivalent to the number of Proprietary Status Frame Bit(s) 124a, 124b, 124c, 124d in Content Frames 120a-120d. Finally, in Step 210, Proprietary Status Frame Bit(s) 124a, 124b, 124c, 124d in Content Frames 120a-120d are modified to collectively contain Digital Certificate 220.

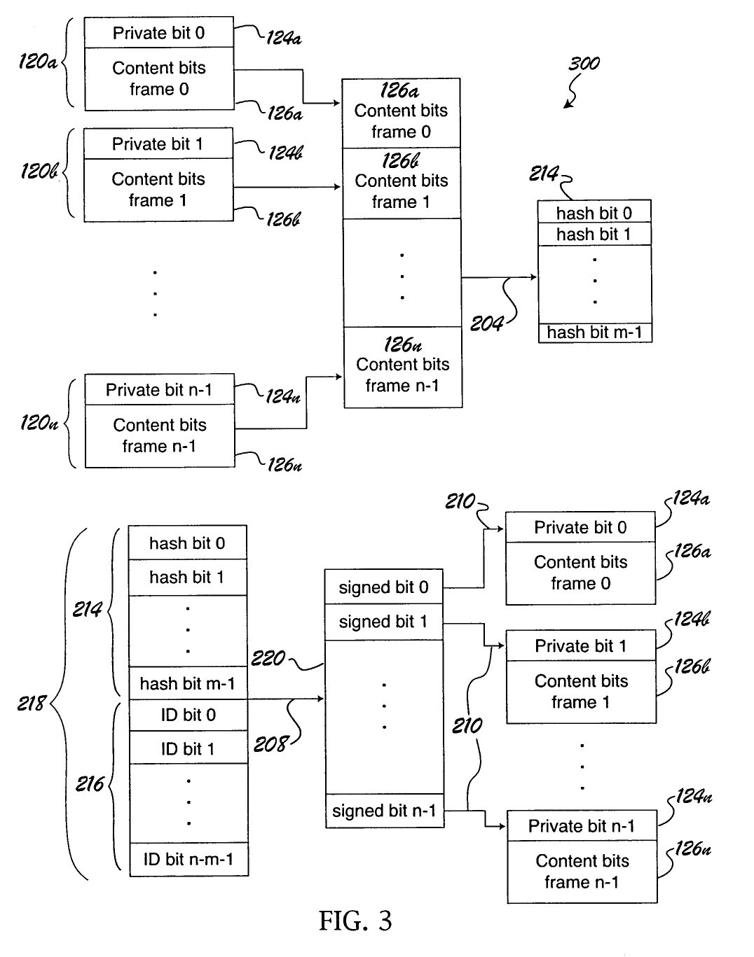

FIG. 3 presents detail in the interrelationship of key data elements used in the steps of Stepwise Authentication Process 200 (FIG. 2), however, with a single proprietary bit in each frame and a large number of Content Frames 120; in this regard, most audio CD products available today have this general data layout. FIG. 3 therefore shows a set of Content Frames 120a-120n, with each content frame having a single Proprietary Status Frame Bit 124a, 124b, . . . , 124n. Content Bits 126a, 126b, . . . , 126n are hashed (note the reprise of Step 204 as a vector in this datalogical depiction to Hash Value 214 which has a smaller number (m) of bits than n). Identifier 216 is appended to Hash Value 214 in Data Object 218 and is encrypted (note also the reprise of Step 208 as a vector) to Digital Certificate 220.

Reviewing detailed considerations shown in FIGS. 1, 2, and 3, content bits from some convenient number n of consecutive content frames are concatenated to establish a temporary data object that is a subset of the content of the overall work without the frame headers (which are simplified in FIG. 3 to a single “private” bit for each frame). A hash value is computed from the temporary content data object using MD5 or some other secure hash function. The hash function produces m≦n bits, so the number of bits available to encode the ID of the licensee of the content will be n-m.

It is of note at this point that, in the special case m=n, there is no space left over for an ID; however, authentication is still possible via an encryption approach in this situation. In this special case, the content is the same for each user and it is economically feasible to use replicated media for distribution. However, as should be apparent, users are able to circulate copies in this instance without worrying as much about the possibility of copies of those copies being traced back to themselves specifically.

Returning to the use of the hash value, the m hash bits and n-m ID bits are next concatenated, and the resulting n bit data object is encrypted using RSA or some other strong public key encryption algorithm. The resulting bits are then used to overwrite the private bits of the n frames. All the information that is needed to verify the authenticity and identify the licensee is therefore made public. This information, including the particular secure hash function and private key encryption algorithm together with the public key, is not sufficient to create copies in which the ID of the licensee has been altered. Therefore, anyone who distributes unauthentic copies can be held responsible, and authentic copies which are made and distributed illegally identify the original licensee.

In an alternative embodiment, choices between alternate versions of each content frame are used to represent the bits of the ID of the licensee (T. J. Nelson in U.S. patent applications Ser. No. 09/519,253, filed Mar. 6, 2000, and 09/767,635 filed Jan. 23, 2001). These alternate content frames are datalogically distinct but artistically equivalent and are advantageously created by the artist during the original production of the work. One advantage of this embodiment is that, while anyone can verify the authenticity of a copy, the public information is not sufficient to allow third parties to identify the licensee.

In yet another embodiment, fundamental data objects (i.e. bytes) each provide at least one bit for security use, without invalidating the data, and the data and security bits are separately concatenated on a large scale to permit strong authentication. For example, 9 bits are sometimes used to represent each 8-bit byte of data in computer memories. The cost of such a memory system is increased by about 12.5%, but corruption of data can be detected with sufficient probability by using the 9^{th} bit as a parity bit. Instead of parity, the authentication process collects the extra bits in some convenient block size, perhaps of 256 bytes. These extra bits are then used to authenticate the data block, thereby providing a defense against computer viruses as well as memory-hardware instability (validating the operational integrity of a digital playing apparatus by validating the proprietary status bits disposed in each content frame commensurate with real-time execution of the content bits in the respective content frame). In further regard to virus detection, even when large scale concatenation is not executed, a re-execution of the authentication method on a work along with comparison to a prior authentication under the same proprietary identifier has value in validating the ongoing consistency of the content frames of the digital work.

In one embodiment, the encrypting algorithm first intermixes the bits of Hash Value 214 and Identifier 216 as an initial sub-step of Step 208.

For maximum authentication, the digital medium containing the digital work identifier is specific to a purchaser of the digital medium, with the proprietary identifier being a distinct data value (such as a Social Security Number or driver's license number). If the medium is downloaded from the Internet, the proprietary identifier is specific to a copier of the digital work and the executable logic to authenticate the data of the full transmission is performed on the server providing the digital work to the copying user. When the purchaser is a customer in a store, the digital medium is conveyed by the customer from a display rack of the store to a clerk in the store. Authentication is then enabled by the clerk of the store through use of a checkout procedure performed on either a general computer or a computer specifically optimized to authenticate the particular digital media marketed by the store, and the modifying step is an overwriting operation to the conveyed medium modifying a first digital certificate specific to the store to a second digital certificate specific to the customer.

If a medium is already validated (i.e. has been purchased “wholesale” by a store for subsequent “retail” sale), a first authentication digital certificate specific to the store is, in one embodiment of use, overwritten on the digital medium at the time of purchase by a retail customer. In this regard, it should be appreciated that the proprietary status of the digital medium, is, in one embodiment, respective to a human custodian of the digital medium in one instance and to an organizational custodian of the digital medium in another instance.

A useful instance of Computer System 100 is provided with a desktop computer having a Pentium 4 CPU, 128 megabytes of random access memory, a CD-RW or DVD-R disk drive, and a 15 inch monitor.

The invention is described herein in a discussion of preferred embodiments, and those of skill will readily appreciate that other embodiments may be substituted from the embodiments described herein without departing from the spirit and scope of the invention; accordingly, the invention should only be limited by the claims included below.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for defining the proprietary status of a digital work disposed in a digital medium, said work having a set of content frames, each content frame having a set of content bits and at least one proprietary status frame bit, said method comprising the steps of:
defining a plurality of said content frames from said set of content frames;
deriving a hash value from the content bits in said plurality of content frames;
appending a digital proprietary identifier to said hash value to define a concatenated data object;
encrypting said concatenated data object to derive a digital certificate having a number of bits equivalent to the number of proprietary status frame bits in said plurality of content frames; and
modifying the proprietary status frame bits in said plurality of content frames to collectively contain said digital certificate.

2. The method of claim 1 wherein each content frame has one proprietary status frame bit.

3. The method of claim 1 wherein said identifier is specific to a purchaser of said digital medium.

4. The method of claim 1 wherein said identifier is specific to a copier of said digital work.

5. The method of claim 1 wherein said content frames are read from said digital medium and said modifying step is an overwriting operation.

6. The method of claim 1 further comprising the step of verifying the proprietary status of said digital medium respective to a human custodian of said digital medium.

7. The method of claim 1 wherein said modifying step is performed through use of the Internet.

8. The method of claim 1 further comprising the step of using said proprietary status bits disposed in each content frame in authenticating said content frame against a datalogical virus.

9. The method of claim 1 further comprising the step of validating the operational integrity of a digital playing apparatus by validating said proprietary status bits disposed in each content frame commensurate with real-time execution of the content bits in the respective content frame.

10. The method of claim 3 wherein said purchaser is a customer in a store, said digital medium is conveyed by said customer from a display rack of said store to a clerk in said store, said steps of defining, deriving, appending, encrypting, and modifying are performed by said clerk of said store through use of a checkout procedure, and said modifying step is an overwriting operation to said conveyed medium modifying a first digital certificate specific to said store to a second digital certificate specific to said customer.

11. A computer apparatus for defining the proprietary status of a digital work disposed in a digital medium, said work having a set of content frames, each content frame having a set of content bits and at least one proprietary status frame bit, said apparatus comprising: means for defining a plurality of said content frames from said set of content frames;
means for deriving a hash value, said means for deriving in data reading communication linkage with the content bits in said plurality of content frames;
means for appending a digital proprietary identifier to said hash value to define a concatenated data object, said means for appending in data reading communication linkage with said hash value;
means for encrypting said concatenated data object to derive a digital certificate having a number of bits equivalent to the number of proprietary status frame bits in said plurality of content frames, said means for encrypting in data reading communication linkage with said concatenated data object; and
means for modifying the proprietary status frame bits in said plurality of content frames to collectively contain said digital certificate, said means for modifying in data reading communication with said digital certificate and in data writing communication with said proprietary status frame bits.

12. The apparatus of claim 11 wherein each content frame has one proprietary status frame bit.

13. The apparatus of claim 11 wherein said identifier is specific to a purchaser of said digital medium.

14. The apparatus of claim 11 wherein said identifier is specific to a copier of said digital work.

15. The apparatus of claim 11 wherein said means for modifying includes a means for overwriting said medium.

16. The apparatus of claim 11 further comprising means, in data reading communication with said content frames, for using said proprietary status bits disposed in each content frame to authenticate said content frame.

17. A computer apparatus for playing a digital work comprising:
a digital medium containing said digital work, said work having a set of content frames, each content frame having a set of content bits and a set of proprietary status frame bits derived from that content frame;
a computer for playing said digital medium; and
means, in said computer, for real-time validation of the operational integrity of said computer respective to said proprietary status bits disposed in each content frame and the content bits in the respective content frame.

18. A digital medium containing a digital work and a proprietary status, said work having a set of content frames, each content frame having a set of content bits and at least one proprietary status frame bit, said medium produced by a process comprising the steps of:
defining a plurality of said content frames from said set of content frames;
deriving a hash value from the content bits in said plurality of content frames;
appending a digital proprietary identifier to said hash value to define a concatenated data object;
encrypting said concatenated data object to derive a digital certificate having a number of bits equivalent to the number of proprietary status frame bits in said plurality of content frames; and
modifying the proprietary status frame bits in said plurality of content frames to collectively contain said digital certificate.

19. A computer apparatus for defining the proprietary status of a digital work disposed in a digital medium, said work having a set of content frames, each content frame having a set of content bits and at least one proprietary status frame bit, said apparatus comprising:
a central processing unit for processing executable logic, said executable logic having:
hash set definition executable logic for defining a plurality of said content frames from said set of content frames;
hash value derivation executable logic for deriving a hash value from said content bits and said plurality of content frames, said hash value derivation executable logic in data reading communication linkage with the content bits in said plurality of content frames defined by said hash set definition executable logic;
identifier appending executable logic for appending a digital proprietary identifier to said hash value to define a concatenated data object, said identifier appending executable logic in data reading communication linkage with said hash value;
encrypting executable logic for encrypting said concatenated data object to derive a digital certificate having a number of bits equivalent to the number of proprietary status frame bits in said plurality of content frames, said encrypting executable logic in data reading communication linkage with said concatenated data object; and
frame modifying executable logic for modifying the proprietary status frame bits in said plurality of content frames to collectively contain said digital certificate, said frame modifying executable logic in data reading communication with said digital certificate and in data writing communication with said proprietary status frame bits.
